(19) United States
(12) Patent Application Publication
(10) Pub. No.: US 2025/0100744 A1
(43) Pub. Date: Mar. 27, 2025

(54) CONTAINER WITH TUBULAR SKIRT

(71) Applicant: ALBEA SERVICES, Gennevilliers (FR)

(72) Inventors: Yann CRAPET, Gennevilliers (FR); Fucai JIANG, Gennevilliers (FR); Furong ZOU, Gennevilliers (FR)

(73) Assignee: ALBEA SERVICES, Gennevilliers (FR)

(21) Appl. No.: 18/409,438

(22) Filed: Jan. 10, 2024

(30) Foreign Application Priority Data
Sep. 22, 2023 (FR) 2310047

(51) Int. Cl. B65D 8/00; A45D 34/04; B65D 35/10

(52) U.S. Cl. CPC B65D 11/02; A45D 34/046; B65D 35/10; A45D 2200/05

(57) ABSTRACT

A container for a cosmetic product can include a tubular skirt forming a reservoir for receiving the cosmetic product, a first end opening, and a second end opening opposite the first end opening. The first end opening can be located in a lower portion of the container and sealed by a cap having a rigidity greater than that of the tubular skirt. The lower portion of the container can include a moulding support fitted inside a circumferential wall of the first end opening. The cap can be arranged at one end of the moulding support and on the circumferential wall of the first end opening and over-moulded onto both the moulding support and onto said circumferential wall.

### CROSS-REFERENCE TO RELATED APPLICATIONS

This application claims priority to French Application No. 2310047, filed on Sep. 22, 2023, the contents of which are incorporated herein by reference in their entirety.

### TECHNICAL FIELD OF THE INVENTION

The application concerns the technical field of cosmetics, and in particular a container for a cosmetic product comprising a tubular skirt forming a reservoir for receiving the cosmetic product.

### TECHNICAL BACKGROUND

Containers of the flexible tube type are known, comprising a head and a tubular skirt attached to the head, in particular a flexible or soft tubular skirt. In particular, the tube is closed at its end opposite the head by welding the edge of the skirt to itself, thus creating a ridge-shaped bottom. In such a configuration, the container must be placed on its head so as to stand upright. This type of configuration makes transport and storage logistics more complex, for example with packaging necessarily by the cover the cover. Furthermore, if the cover does not have a flat surface, boxing and storage can be bulky.

In addition, in this type of container, filling is carried out by the end opposite the head, which is then closed by welding comprising a pressure step.

In the particular case of a container with an applicator end piece attached to a stem and housed in the bottom of the container, the sealing after filling can damage the applicator end piece, particularly during the pressing step.

These flexible tube-type containers are known to improve the delivery of cosmetic product, in particular by applying pressure to the flexible wall of the container. On the other hand, in the particular case of a container with an applicator end piece attached to a stem and housed in the bottom of the container, there is a risk of damaging the applicator end piece if a pressure is exerted on the flexible wall, particularly at the level of the lower portion of the container.

There is therefore a need for a solution that allows to solve at least some of the disadvantages of the prior art while maintaining a product that is simple and economical to manufacture.

### SUMMARY OF THE INVENTION

The invention relates to a container comprising a tubular skirt forming a reservoir for receiving the cosmetic product and further comprising a first end opening, and a second end opening opposite the first end opening,
the first end opening being located in a lower portion of the container and sealed by a cap of greater rigidity than the tubular skirt,
characterised in that the lower portion of the container comprises a moulding support fitted inside a circumferential wall of the first end opening, and
said cap is arranged at one end of the moulding support and on the circumferential wall of the first end opening and over-moulded onto both the moulding support and onto said circumferential wall.

According to different embodiments or examples, which may be taken together or separately:
the lower portion of the container comprises a positioning surface allowing the container to be held stably on a flat support,
the cap is hermetically fitted inside the circumferential wall of the first end opening,
the cap is arranged at the moulding end distant from the reservoir,
the tubular skirt is made of a flexible material,
the container comprises at least one flexible pressure area,
the at least one flexible pressure area corresponding to all or part of 95% of the length of the tube,
the positioning surface is on a peripheral area and/or a central area of the cap,
the cap comprises a central cap portion covering an end of the moulding support opposite the reservoir, and an annular cap sleeve surrounding an external circumference of the central cap portion and provided with a lower portion supportable on the support surface, at least one portion of an external circumferential surface of the cap sleeve being connected to the circumferential wall of the first end opening,
the thickness of the cap is equal to or greater than 1 mm,
the moulding support and the cap are made of the same rigid material,
the moulding support comprises a shell and an annular external skirt arranged around an external circumference of the shell and provided with an external circumferential wall hermetically fitted to the circumferential wall of the first end opening,
the container further comprises a head, a first end of the head is connected to the second end opening, and another end of the head is formed with a dispensing orifice in communication with the reservoir,
one end of the head is connected to the second end opening by over-moulding,
the head houses a wiper,
the head comprises a thread cooperating with a thread of a plug closing the second end.

According to the container provided in the embodiments of the application, on the one hand, the moulding support can act as a seal for the first end opening of the tubular skirt by hermetically fitting the moulding support into the first end opening of the tubular skirt, the reservoir cannot communicate with the outside through the first end opening, while the moulding support also acts as a support for the tubular skirt at the level of the first end opening, which can facilitate the connection between the cap and the first end opening. On the other hand, the rigidity of the cap is greater than that of the tubular skirt, so that the cap can completely close the first end opening without changing the structure of the first end opening of the tubular skirt, while improving the rigidity and the support performance of the bottom of the container. The container can be held vertically on the support surface by the cap of the container.

The invention also concerns a device for packaging and applying a cosmetic product, in particular mascara.

The device comprises:
a container as described above, and
an applicator assembly comprising a plug comprising an application member capable of closing or opening the dispensing orifice, and an applicator end piece connected to one end of the application member, capable of extending into or extract out of the reservoir through the dispensing orifice.

Advantageously, the plug comprises a base, the application member comprises: a connector fitted into the base, and a stem provided with a first end extending into and connected to the connector and another end connected to the applicator end piece. The head, in particular at the level of the neck, is removably fitted into the connector by means of a threaded connection, so that the application member closes or opens the dispensing orifice.

Advantageously, the applicator end piece is a mascara and/or a lip product applicator end piece.

The invention also relates to a method for manufacturing a container as described above, wherein the moulding support is first fitted over the circumferential wall of the first end opening and then an injection moulding to form the cap is performed through an end of the moulding support distant from the reservoir at the level of the circumferential wall of the first end opening.

### BRIEF DESCRIPTION OF THE FIGURES

Further characteristics and advantages of the invention will become apparent from the following detailed description, for the understanding of which reference is made to the attached drawings in which:

FIG. 1 is a perspective view of a container in one embodiment of the application,

FIG. 2 is a side view of the container shown in FIG. 1,

FIG. 3 is a cross-sectional view along AA of the structure shown in FIG. 2,

FIG. 4 is an enlarged B view of the structure shown in FIG. 3,

FIG. 5 shows a side view of the container in FIG. 1 without the plug,

FIG. 6 is an exploded perspective view of FIG. 5,

FIG. 7 is an enlarged view of the lower portion of a container as shown in FIG. 1, according to a variant embodiment of the application,

FIG. 8 is an enlarged view of the lower portion of a container as shown in FIG. 1, according to another variant of embodiment of the application.

### DETAILED DESCRIPTION OF THE INVENTION

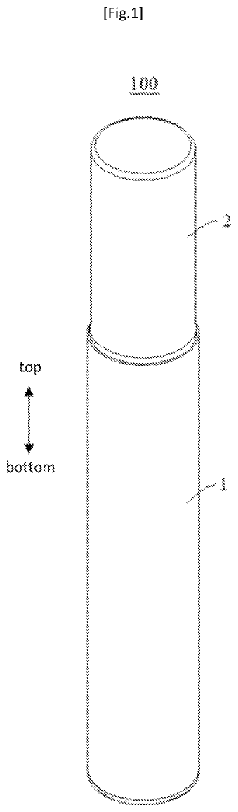

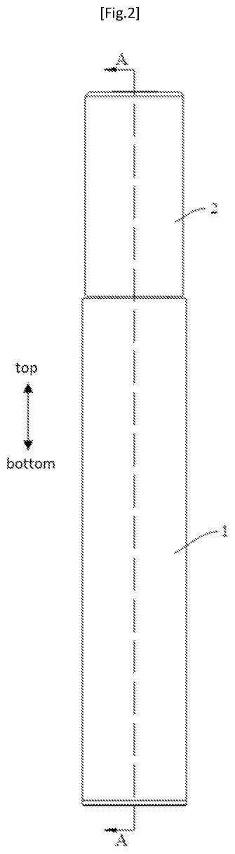

In the remainder of the description, the terms “top”, “bottom”, “upper”, “lower” have orientation or positional relationships based on the orientation or positional relationships of FIGS. 1 to 3, and it should be understood that these orientation terms are intended only to facilitate and simplify the description, and are not intended to indicate or imply that a referenced device or element must have a particular orientation, configure and operate in a particular orientation, and therefore cannot be understood as a limitation of the application.

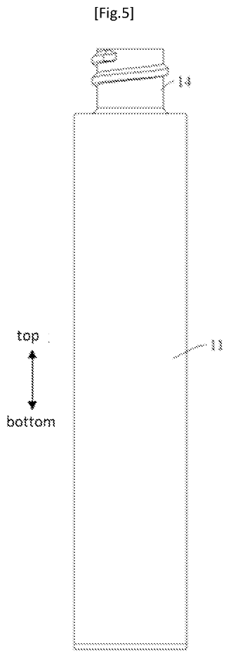

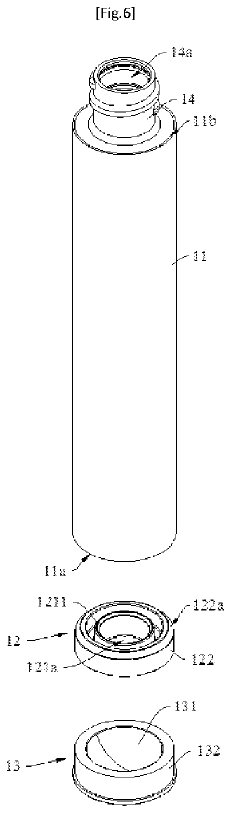

One embodiment of the application proposes a container 100. With reference to FIGS. 1 to 8, the container 100 comprises a tubular skirt 11, a moulding support 12 and a cap 13, hereinafter also referred to as the lower cap 13. The container 100 is capable of storing and containing cosmetic products. The cosmetic products comprise, but are not limited to, liquid, fluid or viscous substances such as nail varnish, mascara, lipstick, face cream, gel, foundation, concealer, lotion, skin moisturiser, sun cream, etc.

The tubular skirt 11 is formed by a first end opening 11a, a second end opening 11b opposite the first end opening 11a, and a reservoir 11c in communication with the first end opening 11a and the second end opening 11b. More specifically, the tubular skirt 11 has a hollow cylindrical structure with openings at its upper and lower ends. An axial direction of the tubular skirt 11 conforms with an upper-lower direction, and an internal circumferential wall of the tubular skirt 11 forms the reservoir 11c by surrounding it.

The first end opening 11a is located in a lower portion of the container. It is sealed by the lower cap 13.

The moulding support 12 has an external circumferential wall fitted over a circumferential wall of the first end opening 11a. In other words, the moulding support 12 is located in a lower portion of the tubular skirt 11. It is fitted into the first end opening 11a and is connected to the circumferential wall of the first end opening 11a.

Preferably, the external circumferential wall is fitted hermetically onto the circumferential wall of the first end opening 11a. In other words, the moulding support 12 is hermetically connected to the circumferential wall of the first end opening 11a.

After fitting, when an external circumferential wall of the tubular skirt 11 at the level of the first end opening 11a is subjected to a pressure in a radial direction, the moulding support 12 located in the first end opening 11a can provide a support to the tubular skirt 11 in the radial direction, to prevent the deformation of the first end opening 11a, while the reservoir 11c cannot communicate with the outside through the first end opening 11a.

The lower cap 13 is arranged at one end of the moulding support 12, in this case away from the reservoir 11c, and on the circumferential wall of the first end opening 11a.

According to the invention, the lower cap 13 is over-moulded both on the moulding support 12 and on said circumferential wall of the first end opening 11a.

Advantageously, the lower portion of the container comprises a positioning surface allowing the container to be held stably on a flat support.

Preferably, the positioning surface is on a peripheral area and/or a central area of the cap.

Here, the lower cap 13 is provided with a lower portion that can be supported on a support surface, for example a flat support, on which the user can place the container 100 upright. More precisely, the support surface is a surface parallel to a horizontal direction, and a lower end of the lower cap 13 may be a plane perpendicular to the axial direction of the tubular skirt 11, or may have a structure of several branches with the same horizontal heights, so that the container 100 can stand upright on the support surface by means of the lower cap 13. In addition, the lower cap 13 is simultaneously connected to the end of the moulding support 12 distant from the reservoir 11c and to the circumferential wall of the first end opening 11a, thereby completely closing the first end opening 11a, so that the lower cap 13, the moulding support 12 and the first end opening 11a together form the bottom of the container 100.

The rigidity of the lower cap 13 is relatively greater than that of the tubular skirt 11, improving the rigidity and the support performance of the bottom of the container 100, without changing the structural shape of the first end opening 11a of the tubular skirt 11.

In one embodiment, the tubular skirt 11 is made of a flexible material and/or the moulding support 12 is made of a rigid material and/or the lower cap 13 is made of a rigid material.

The flexibility of the material making up the tubular skirt 11 refers to the suppleness of the material of the tubular skirt 11, so that the material can be easily deformed, or bent or crushed without breaking, in particular when pressed by the user's hand or finger, for example to bring cosmetic product to the applicator end piece 22. For example, in the case of the container 100, when liquid is injected into the reservoir 11c of the tubular skirt 11, or when a pressure is applied to it with the fingers or the hands, the tubular skirt 11 changes shape without breaking.

The rigidity of the material making up the moulding support 12 and/or the lower cap 13 refers to a material that cannot be deformed by atmospheric pressure or the pressure applied by the fingers or the hands of a user.

Advantageously, the container thus comprises at least one flexible pressure area. In other words, at least in one area, in particular at the level of the tubular skirt, a pressure can be exerted without the material being damaged, broken, punctured or deteriorated. This may involve, for example, a pressure being applied to the flexible pressure area with the fingers or the hands, causing a change in shape, such as a crushing or a pinching, of the tubular skirt 11.

Advantageously, the at least one flexible pressure area corresponds to all or part of 95% of the length of the tube.

Preferably, the at least one flexible pressure area is free, in a radial plane, of rigid elements.

The manufacturing methods for the tubular skirt 11 are not specifically limited. In one embodiment, the tubular skirt 11 is made from a thin flat strip, preferably rectangular. The flat strip is rolled into a tubular shape and then two opposite lateral edges of the flat strip are joined together, so that a cylindrical tubular skirt 11 formed with openings at both ends can be manufactured. The two lateral edges of the strip are assembled by a longitudinal weld to form the tubular skirt 11. The longitudinal weld can be obtained by overlapping the lateral edges or by placing the lateral edges opposite each other.

In another embodiment, the tubular skirt 11 is manufactured by extrusion moulding.

In one embodiment, the tubular skirt 11 is made of a multi-layer material which comprises, but is not limited to, the multi-layer plastic materials. More specifically, the multi-layer material of the tubular skirt 11 comprises at least an internal layer, a barrier layer and an external layer, the barrier layer being sandwiched between the internal layer and the external layer along a thickness direction of a tube wall of the tubular skirt 11. The internal layer consists of a polyethylene material, for example, the internal layer consists of high density polyethylene with a proportion of 80% and low density polyethylene with a proportion of 20%. The external layer also consists of a polyethylene material, for example, the external layer consists of 100% high-density polyethylene. The barrier layer comprises, but is not limited to, a layer of ethylene vinyl alcohol (EVOH) or a layer of aluminium. For example, the barrier layer is made up of ethylene vinyl alcohol, which is a polymer that acts as a barrier to oxygen and aromas and can limit the loss of fragrance or flavour of a packaged product.

In one embodiment, the materials of the moulding support 12 include, but are not limited to, the use of a polyethylene material.

In one embodiment, the materials of the lower cap 13 comprise, but are not limited to, the use of a polyethylene material.

Preferably, the moulding support 12 and the lower cap 13 are made of the same rigid material.

The bottom of a container made from a flexible material is usually closed by high-pressure fusion welding under heating conditions to form a ridge-shaped bottom. Because of the ridge-shaped bottom, the container cannot be placed vertically, which can lead to a more complex packaging and transport process. For example, the container should be packed upside down, with the plug facing downwards. Where the plug does not have a flat surface either, it may require additional attachment elements to facilitate packaging when packing the container.

Furthermore, when the container is a container intended to store cosmetic products such as mascara, lipstick, etc., i.e. a container comprising a structural element for removing the cosmetic products, such as an applicator end piece, when the container made of the flexible material is deformed by an external force, there will be a risk of damaging the structural element of the container.

According to the container 100 provided in the embodiment of the application, on the one hand, the moulding support 12 can play a role of sealing the first end opening 11a of the tubular skirt 11 by hermetically fitting the moulding support 12 into the first end opening 11a of the tubular skirt 11, the reservoir 11c cannot communicate with the outside through the first end opening 11a.

On the other hand, the moulding support 12 also acts as a support for the tubular skirt 11 at the level of the first end opening 11a, which can facilitate the connection between the lower cap 13 and the first end opening 11a.

In addition, the rigidity of the lower cap 13 is greater than that of the tubular skirt 11, so that the lower cap 13 can completely close the first end opening 11a without changing the structural shape at the level of the first end opening 11a of the tubular skirt 11, while improving the rigidity and the supporting performance of the bottom of the container 100. The container 100 can be supported vertically on the support surface by means of the lower cap 13 of the container 100.

In one embodiment, the lower cap 13 is formed integrally with the moulding support 12 and the first end opening 11a by an injection moulding process. For example, the moulding support 12 is first fitted, preferably hermetically, onto the circumferential wall of the first end opening 11a, and then injection moulding to form the lower cap 13 is performed through the end of the moulding support 12 distant from the reservoir 11c at the level of the circumferential wall of the first end opening 11a. More specifically, the end of the moulding support 12 distant from the reservoir 11c and the circumferential wall of the first end opening 11a form a cavity-shaped surface for injection moulding of an upper end of the lower cap 13, and a mould nucleus of an injection moulding machine forms a cavity-shaped surface for the lower end of the lower cap 13. Once the two cavity-shaped surfaces of the upper and lower ends of the lower cap 13 are aligned and closed together, a cavity (i.e. a mould) for the injection moulding of the lower cap 13 is formed.

The molten raw materials for the injection moulding are then poured into the cavity for performing the injection moulding. The mould is opened once the raw materials for the injection moulding have cooled. As a result, the lower cap 13 linked respectively to the moulding support 12 and to the first end opening 11a is formed.

The structures of one side of the lower cap 13 connected to the moulding support 12 and the first end opening 11a correspond to the contour shapes of the moulding support 12 and the first end opening 11a respectively. The structures of the side of the lower cap 13 distant from the moulding support 12 and the first end opening 11a are not particularly limited, for example, the lower end of the lower cap 13 may be a plane perpendicular to the axial direction of the tubular skirt 11. By way of example, in one embodiment, the thickness of the lower cap 13 is equal to or greater than 1 mm. That is, the lower cap 13 is a coating layer of a certain thickness which covers a lower end of the moulding support 12 and the circumferential wall of the first end opening 11a after injection moulding, and the thickness of the coating layer is equal to or greater than 1 mm.

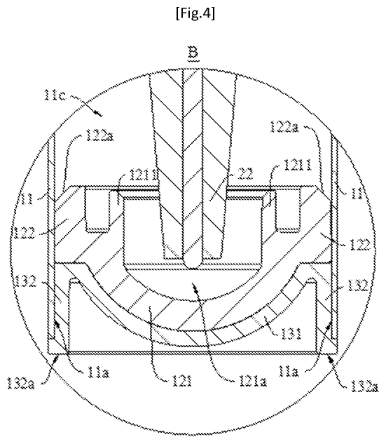

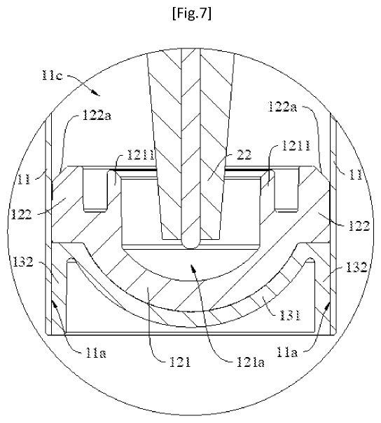

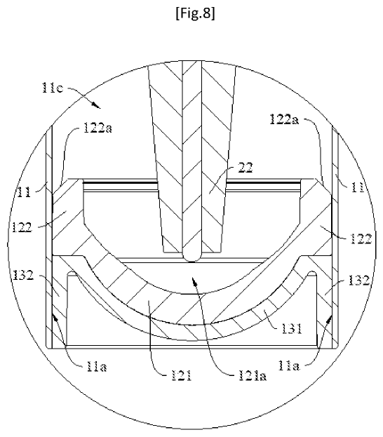

In one embodiment, with reference to FIG. 4, and in the alternative embodiments shown in FIGS. 7 and 8, the lower cap 13 comprises a central cap portion 131 and an annular cap sleeve 132. The central portion of the cap 131 covers the end of the moulding support 12 opposite the reservoir 11c. The cap sleeve 132 surrounds an external circumference of the central cap portion 131.

The cap sleeve 132 is provided with a lower portion that can be supported on the support surface.

In addition, at least a portion of an external circumferential surface of the cap sleeve 132 is connected to the circumferential wall of the first end opening 11a.

Advantageously, the contour of the central cap portion 131 forms a coating layer complementary to the contour of the lower end of the moulding support 12, and the external circumferential surface of the cap sleeve 132 forms a coating layer connected to the circumferential wall of the first end opening 11a.

The thickness of each of the central cap portion 131 and the cap sleeve 132 is equal to or greater than 1 mm, so that the lower cap 13 has a greater rigidity than the tubular skirt 11. After injection moulding, the lower cap 13 is connected to the moulding support 12 and to the first end opening 11a, so that its strength is higher and its support performance is better.

In the example shown in FIGS. 1 to 6, the bottom of the cap sleeve 132 is formed with an annular plane 132a covering an axial end of the first end opening 11a, and the container 100 can be supported on the support surface vertically by means of the annular plane 132a of the lower cap 13.

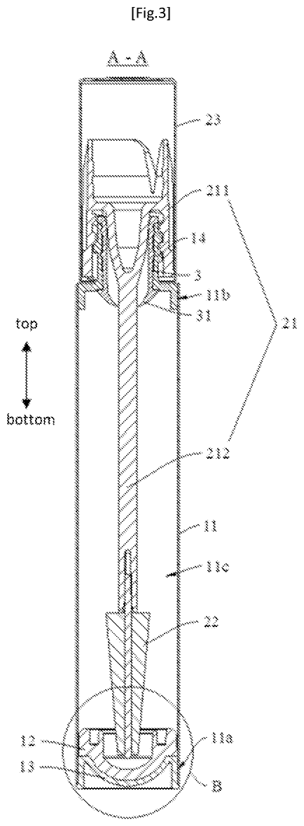

In the alternative embodiments shown in FIGS. 7 and 8, the bottom of the cap sleeve 132 has no annular plane 132a. The tubular skirt 11 descends to the lower edge of the cap sleeve 132. The container 100 is then supported on the support surface vertically by means of a lower periphery of the lower cap 13 delimited by the lower edge thereof. In one embodiment, with reference to FIGS. 3, 4, 7 and 8, the moulding support 12 comprises a shell 121 and an annular external skirt 122. The external skirt 122 is arranged around an external circumference of the shell 121 and is provided with an external circumferential wall fitted hermetically onto the circumferential wall of the first end opening 11a. More specifically, the structures and the shapes of the shell 121 are not particularly limited. The shell 121 can be a plate-shaped structure arranged in the horizontal direction, or can be a structure with other shapes. A lower end of the external skirt 122 is connected to an external circumferential edge of the shell 121, and an upper end of the external skirt 122 extends upwards along the axial direction of the tubular skirt 11 towards the second end opening 11b. The external skirt 122 allows to increase an area of contact between the moulding support 12 and the circumferential wall of the first end opening 11a, thereby achieving an improved sealing performance.

In one embodiment, with reference to FIGS. 3, 4 and 7, the shell 121 is formed with an annular flange 1211 extending towards the second end opening 11b. More specifically, the annular flange 1211 is located on a surface of a side of the shell 121 distant from the first end opening 11a, and a support column can be fitted into the annular flange 1211.

When injection moulding the lower cap 13, it may be advantageous to provide a support structure such as a stem-shaped support column. The support column is then supported at an end of the moulding support 12 distant from the first end opening 11a to facilitate the axial positioning of the moulding support 12 at the level of the first end opening 11a of the tubular skirt 11. Advantageously, the annular flange 1211 can be used for this purpose. The annular flange 1211 is then fitted onto the support column, making it easier to install and hold the support column.

By way of example, in one embodiment, during the injection moulding of the lower cap 13, the support column extends into the tubular skirt 11 from the second end opening 11b, and is then fitted into the annular flange 1211, so that the moulding support 12 is arranged in a predefined position at the level of the first end opening 11a, thus avoiding the occurrence of an axial sliding of the moulding support 12 along the tubular skirt 11 during the injection moulding of the lower cap 13. The annular flange 1211 can constrain a predefined position where the support column is supported on the moulding support 12, ensuring that the support column is reliably supported at the end of the moulding support 12 distant from the first end opening 11a during injection moulding of the lower cap 13. Once the lower cap 13 has been injection moulded, the support column is separated from the annular flange 1211 and protrudes through the second end opening 11b.

In a variant embodiment illustrated in FIG. 8, the shell 121 does not comprise an annular flange 1211. When the lower cap 13 is injection moulded, the support column rests directly on the shell 121.

In one embodiment, with reference to FIGS. 3, 4, 7 and 8, an end of the external skirt 122 distant from the shell 121 is formed with an annular guide surface 122a configured to guide the external skirt 122 as it is fitted into the first end opening 11a. The annular guide surface 122a can facilitate the mounting and fitting of the moulding support 12 into the first end opening 11a. On a projection plane perpendicular in the axial direction of the tubular skirt 11, a projection contour area of an upper end of the annular guide surface 122a is smaller than a projection contour area of a lower end of the annular guide surface 122a. The annular guide surface 122a may be an arcuate or conical annular surface with a smooth transition from top to bottom.

In one embodiment, with reference to FIGS. 3, 4, 7 and 8, the shell 121 is formed of a hollow 121a open towards the reservoir 11c. More specifically, the hollow 121a communicates with the reservoir 11c, and a central area of the shell 121 is depressed in a direction away from the reservoir 11c to form the hollow 121a.

In the variant embodiment illustrated in FIGS. 3, 4 and 7, the annular flange 1211 is arranged to surround an external circumference of the hollow 121a. The hollow 121a and the annular flange 1211 thus form a space which together further facilitate the installation of the support column for the axial pre-positioning of the moulding support 12 during injection moulding of the lower cap 13.

The shape of a lower surface of the hollow 121a is not particularly limited and comprises, but is not limited to, a flat plane, an arcuate surface, a conical surface, etc. By way of example, in one embodiment, with reference to FIGS. 3, 4, 7 and 8, the lower surface of the hollow 121a is a spherical surface. More specifically, the spherical surface is a concave spherical surface depressed in the direction away from the reservoir 11c. Thus, when the first end opening 11a is compressed by an external force along the axial or radial direction of the tubular skirt 11, the hollow 121a of the spherically shaped shell 121 can reduce the stresses of the shell 121, improves the compressive strength of the shell 121 as a whole, improves the support/holding performance of the moulding support 12, and greatly avoids the occurrence of deformation of the tubular skirt 11 at the level of the first end opening 11a. In addition, the spherical hollow 121a does not take up too much space inside the tubular skirt 11, and the storage volume of the reservoir 11c remains large.

In one embodiment, with reference to FIGS. 3, 5 and 6, the container 100 further comprises a head 14, a first end of the head 14 is connected to the second end opening 11b, and another end of the head 14 is formed with a dispensing orifice 14a in communication with the reservoir 11c.

More specifically, the head 14 comprises a shoulder and a neck. The shoulder is the portion of the head connected to the tubular skirt at the level of the second end opening 11b. The neck is the end of the head 14 formed by a dispensing orifice 14a.

More specifically, the head 14 is connected to the tubular skirt 11 by injection moulding at the level of the shoulder. Preferably, the head is moulded onto the second end of the tubular skirt.

The head 14 has a hollow tubular structure with openings at its upper and lower ends. The head 14 is made of a rigid material to improve the structural strength of the container 100 at the level of the second end opening 11b of the tubular skirt 11.

As illustrated here, the container can be assembled with an applicator assembly to form a device for packaging and applying a cosmetic product, in particular mascara or a lip product.

The applicator assembly comprises a plug 2, the plug 2 comprises an application member 21 and an applicator end piece 22. The application member 21 is capable of closing or opening the dispensing orifice 14a. The applicator end piece 22 is connected to one end of the application member 21 and is capable of extending into or extract out of the reservoir 11c through the dispensing orifice 14a. The applicator end piece 22 is at least partially located in the hollow 121a when the application member 21 closes the dispensing orifice 14a. More specifically, the applicator end piece 22 can be a applicator end piece for mascara such as a brush and/or for a lip product. The applicator end piece 22 may or may not be flocked and/or may comprise protuberances projecting radially from the surface of the applicator end piece 22.

In this case, when the application member 21 closes the dispensing orifice 14a, the applicator end piece 22 is located in the reservoir 11c and when the application member 21 opens the dispensing orifice 14a, the applicator end piece 22 follows the application member 21 to be withdrawn from the reservoir 11c through the dispensing orifice 14a. Once the applicator end piece 22a has been removed from the dispensing orifice 14a, the cosmetic product on the applicator end piece 22 can be applied by the user.

When the container 100 is a container intended to store cosmetic products such as mascara, lipstick, etc., the applicator end piece 22 for picking up cosmetic products is generally housed in the container 100. When the tubular skirt 11 is made of a flexible material, the tubular skirt 11 deforms easily when subjected to an external force and there is then a risk of damaging the applicator end piece 22 inside the tubular skirt 11. The hollow 121a is made of a rigid material, and the applicator end piece 22 is at least partially arranged in the hollow 121a, so that the hollow 121a can act as a support and protection for the applicator end piece 22, preventing a compression and/or a crushing of the applicator end piece 22 inside the tubular skirt 11.

In another embodiment not shown, the applicator end piece 12 is distant from the hollow 121a.

By way of example, in one embodiment, with reference to FIG. 3, the plug 2 comprises a base 23, the application member 21 comprises a connector 211 and a stem 212. The connector 211 is fitted into the base 23. The stem 212 has a first end extending into and connected to the connector 211, and another end connected to the applicator end piece 22. The head 14, in particular at the level of the neck, is removably fitted into the connector 211 by means of a threaded connection, so that the application member 21 closes or opens the dispensing orifice 14a. More specifically, an external circumferential wall of the head 14, here at the level of the neck, is formed with external threads, an internal circumferential wall of the connector 211 is formed with internal threads. The external threads are fitted onto the internal threads. The head 14 and the application member 21 can only be separated or joined by relative rotation, which prevents the head 14 from being separated from the application member 21 when the container 100 is accidentally subjected to a large external force. In other words, the container 100 can only be opened or closed by relative rotation of the head 14 and the application member 21, which prevents the container 100 from being opened when the container 100 is accidentally subjected to a significant external force. The connection between the head 14 and the application member 21 is highly reliable.

In one embodiment, with reference to FIG. 3, the container 100 also comprises a wiper 3, the wiper 3 being housed in the head 14.

More specifically, the wiper 3 is located at the level of the dispensing orifice 14a and is fitted onto an internal wall surface of the head 14, at the level of the neck. When the application member 21 covers the reservoir 11c, the wiper 3 can seal a gap between the application member 21 and the neck of the head 14. The wiper 3 seals the container 100 and allows to prevent substances from leaking out of the reservoir 11c.

The materials of the wiper 3 are not limited. For example, rubber or silicone materials can be chosen as materials for the wiper 3.

In one embodiment, with reference to FIG. 3, the lower end of the wiper 3 is constricted to form a scraping portion 31, and a minimum inside diameter of the scraping portion 31 is smaller than a maximum outside diameter of the applicator end piece 22.

In this way, when the user removes the applicator end piece 22 for use, the scraping portion 31 can come into contact with the applicator end piece 22, and the user can adjust the amount of cosmetic product stored by the applicator end piece 22, improving the user's comfort of use and reducing the waste of cosmetic product caused by an excessive soaking.

The above description is only of specific embodiments of the application, however, the scope of protection is not limited thereto. The variations or substitutions that are easily conceivable by any technical person familiar with this technical field must fall within the scope of protection of the application.

1. A container for a cosmetic product, comprising a tubular skirt forming a reservoir for receiving the cosmetic product and further comprising a first end opening, and a second end opening opposite the first end opening,
the first end opening being located in a lower portion of the container and sealed by a cap having a rigidity greater than that of the tubular skirt,
characterised in that the lower portion of the container comprises a moulding support fitted inside a circumferential wall of the first end opening, and
said cap is arranged at one end of the moulding support and on the circumferential wall of the first end opening and over-moulded onto both the moulding support and onto said circumferential wall.

2. The container as claimed in claim 1, wherein the lower portion of the container comprises a positioning surface allowing the container to be held stably on a flat support.

3. The container according to claim 1, wherein the tubular skirt is made of a flexible material.

4. The container according to claim 3 comprising at least one flexible pressure area.

5. The container according to claim 4, wherein the at least one flexible pressure area corresponds to all or part of 95% of a length of the tube.

6. The container according to claim 2, wherein the positioning surface is on a peripheral area and/or a central area of the cap.

7. The container according to claim 1, wherein the cap comprises a central cap portion covering an end of the moulding support opposite the reservoir, and an annular cap sleeve surrounding an external circumference of the central cap portion and provided with a lower portion supportable on the support surface, at least one portion of an external circumferential surface of the cap sleeve being connected to the circumferential wall of the first end opening.

8. The container according to claim 1, wherein a thickness of the cap is equal to or greater than 1 mm.

9. The container according to claim 1, wherein the moulding support and the cap are made of the same rigid material.

10. The container according to claim 1, wherein the moulding support comprises a shell and an annular external skirt arranged around an external circumference of the shell and provided with an external circumferential wall hermetically fitted over the circumferential wall of the first end opening.

11. The container according to claim 1, wherein the container further comprises a head, a first end of the head is connected to the second end opening, and another end of the head is formed with a dispensing orifice in communication with the reservoir.

12. The container according to claim 11, wherein one end of the head is connected to the second end opening by over-moulding.

13. A device for packaging and applying a cosmetic product, in particular mascara, comprising:
a container according to claim 1,
an applicator assembly comprising a plug comprising an application member capable of closing or opening a dispensing orifice, and an applicator end piece connected to one end of the application member, capable of extending into or out of the reservoir through the dispensing orifice.

14. The device according to claim 13, wherein the plug comprises a base, the application member comprises: a connector fitted into the base, and a stem provided with a first end extending into and connected to the connector and another end connected to the applicator end piece, a head is removably fitted into the connector by means of a threaded connection, so that the application member closes or opens the dispensing orifice.

15. The device according to claim 14, wherein the applicator end piece is a mascara and/or lip product applicator end piece.

16. A method for manufacturing a container according to claim 1, wherein the moulding support is first fitted over the circumferential wall of the first end opening and then an injection moulding to form the cap is performed through an end of the moulding support distant from the reservoir at a level of the circumferential wall of the first end opening.
